(19) United States
(12) Patent Application Publication
(10) Pub. No.: US 2019/0096282 A1
(43) Pub. Date: Mar. 28, 2019

(54) Math-wars card game

(71) Applicant: SuEllen Hoeflinger Hotchkiss, Live Oak, TX (US)

(72) Inventor: Gregory Lyle Hotchkiss, Live Oak, TX (US)

(21) Appl. No.: 15/732,141

(22) Filed: Sep. 25, 2017

(51) Int. Cl. G09B 19/02; G09B 19/22; G09B 1/34

(52) U.S. Cl. CPC G09B 19/02; G09B 1/34; G09B 19/22

(57) ABSTRACT

A math-wars card game includes play area and at least two players. Number cards each identify single number from different numbers such that there is at least one number card for each number. Operator cards each identify single mathematical operator from different operators such that there is at least one operator card for each operator. To begin play, in first of successive battles, at least three number cards are laid in row on play area with respective numbers exposed and one fewer number of operator cards are laid between corresponding consecutive laid number cards with respective operators exposed such that exposed numbers and operators present unsolved mathematical equation. Winner of first battle is determined as player first providing correct solution to equation. All laid cards from first battle are given to winner. Consecutive battles are continued until one player holds predetermined number of number and operator cards or number cards.

### BACKGROUND OF INVENTION

### 1. Field of Invention

The invention relates, generally, to the field of education and, more particularly, to a method for playing an educational card game that teaches basic mathematical skills.

### 2. Description of Related Art

For people interested in science, art, engineering, mathematics, computer science, innovation, and entrepreneurship, mastering basic mathematical skills is critical. Yet, this can prove to be a difficult task for some people. Children especially often struggle to understand various mathematical concepts because they are often viewed as too abstract or remote.

Educational card games that teach basic mathematical skills are known. For example, flash cards may be used to teach mathematical facts. Unfortunately, however, they may not provide for a competitive, entertaining, and fun learning environment. Also, many of them do not entail competitive play between/among players thereof.

Also, U.S. Patent Application Publication 2007/0138745 entitled “Educational Card Game and Related Methods of Use Therefor” discloses playing cards that enable players of the game to practice mathematical operations (e.g., addition, subtraction, multiplication, division, etc.) involving real numbers and integers based upon traditional card games, such as “War” and “Spades.” More specifically, each card defines a “value” side, which may identify an integer, and “non-value” side of the card. During play of each round of the game, the players reveal the value side of one of their respective cards at the same time, and a winner of the round is determined by the player to first reveal a correct outcome of the revealed cards applied to a predetermined mathematical operation. To break a tie in the round, each player places “value side” down at least two new cards and reveals the value side of one of these cards at the same time as the other player does so. A winner of the tie-breaker round is determined by the player to first reveal a correct outcome of the newly revealed cards applied to the predetermined mathematical operation and collects the initial cards played during the tied round plus the additional cards played during the tie-breaker round. A winner of the game is the player holding most or all of the cards at an end of all rounds of play. However, the purpose of the game is to merely increase memorization or recollection by rote of multiplication tables of integers zero through twelve and addition, subtraction, or division. In other words, the game does not increase understanding and practice of proper ordering of multiple mathematical operations in an unsolved equation to further enhance more complex mathematical and strategic-thinking skills.

Thus, there is still a need in the related art for ways to interest or excite children about learning mathematics. More specifically, there is such a need that conveys mathematical concepts to children in a manner to which they can practically relate and by using their interest in games. In that regard, there is a need for a game that requires fast thinking. There is a need for such a game that also can be enjoyed by a wide range of ages, including children and adults. There is a need for such a game that also does not merely increase memorization or recollection by rote of multiplication tables of integers. There is a need for such a game that also allows players thereof to understand and practice proper ordering of multiple mathematical operations in an unsolved equation, which further enhance the players' more complex mathematical and strategic-thinking skills.

And, because a certain venue—e.g., teaching in a school classroom or travel in a car or airplane—may prohibit use of electronic devices, a card game that satisfies these needs is desirable. In particular, it would be desirable to integrate use of a broad range of mathematical operations, relationships, and negative numbers into a card game to provide amusement to all players involved in the game. It would be desirable also to have a card game that allows players thereof to use their mathematical skills in a fun, unique way. It would be desirable to have such a card game that also is designed to suit any venue in an inexpensive way.

SUMMARY OF INVENTION

The invention satisfies these needs and desires in a method of playing a math-wars card game. The method includes steps of providing a play area of the game and at least two players to play the game. A set of number cards is provided each of which identifies a single number from different numbers such that there is at least one number card for each number. A set of operator cards is provided each of which identifies a single mathematical operator from different mathematical operators such that there is at least one operator card for each mathematical operator. To begin play of the game, in a first of successive battles of the game, at least three number cards are laid in a row on the play area with the respective numbers exposed and one fewer number of operator cards are laid between corresponding consecutive laid number cards with the respective mathematical operators exposed such that the exposed numbers and mathematical operators present an unsolved mathematical equation. A winner of the first battle is determined as the player who first provides a correct solution to the unsolved mathematical equation. All of the laid cards from the first battle are given to the winner of the first battle. The consecutive battles are continued until one of the players holds a predetermined number of number cards and operator cards or number cards.

The math-wars card game of the invention is educational and teaches basic mathematical facts and skills.

The math-wars card game of the invention provides for a competitive, entertaining, and fun learning environment.

The math-wars card game of the invention entails competitive play between/among players thereof.

The math-wars card game of the invention interests and excites children about learning mathematics.

The math-wars card game of the invention conveys mathematical concepts to children in a manner to which they can practically relate and by using their interest in games.

The math-wars card game of the invention requires fast thinking.

The math-wars card game of the invention can be enjoyed by a wide range of ages, including children and adults.

The math-wars card game of the invention does not require use of any electronic device.

The math-wars card game of the invention integrates use of a broad range of mathematical operations, relationships, and negative numbers to provide amusement to all players involved in the game.

The math-wars card game of the invention does not merely increase memorization or recollection by rote of multiplication tables of integers.

The math-wars card game of the invention allows players thereof to understand and practice proper ordering of multiple mathematical operations in an unsolved equation, which further enhance the players' more complex mathematical and strategic-thinking skills.

The math-wars card game of the invention allows players thereof to use their mathematical skills in a fun, unique way.

The math-wars card game of the invention is designed to suit any venue in an inexpensive way.

Those having ordinary skill in the related art should readily appreciate objects, features, and advantages of the math-wars card game of the invention as it becomes more understood while the subsequent detailed description of exemplary embodiments of the card game is read taken in conjunction with an accompanying drawing thereof.

### BRIEF DESCRIPTION OF EACH FIGURE OF DRAWING OF INVENTION

FIG. 1 is a flow chart showing steps of an exemplary embodiment of a math-wars card game of the invention;

FIGS. 2A-2M are “face up” views of an exemplary embodiment of respective number cards of the exemplary embodiment of the math-wars card game of the invention, wherein the number cards respectively identify consecutive whole numbers from zero to twelve;

FIGS. 3A-3C are “face up” views of an exemplary embodiment of respective operator or symbol cards of the exemplary embodiment of the math-wars card game of the invention, wherein the operator cards respectively identify mathematical operators of addition, subtraction, and multiplication;

FIG. 4 is an elevational view of an unsolved mathematical equation of the math-wars card game of the invention, wherein four of the number cards shown in FIGS. 2A-2M are laid in a row on a play area of the math-wars card game with the respective numbers exposed and the three operator cards shown FIGS. 3A-3C are laid between corresponding consecutive laid number cards with the respective mathematical operators exposed; and

FIGS. 5A-5C are elevational views of respective charts or tables for addition, multiplication, and subtraction of the whole numbers zero to twelve shown in FIGS. 2A-2M of the exemplary embodiment of the math-wars card game of the invention, wherein the charts are for use to verify a correct solution of an unsolved mathematical equation presented by application of the respective mathematical operators to any pair of the numbers.

### DETAILED DESCRIPTION OF EXEMPLARY EMBODIMENTS OF INVENTION

Referring now to the figures, throughout which like numerals are used to designate like structure, a math-wars card game and method of playing it according to the invention, in various non-limiting exemplary embodiments thereof, are generally indicated at 10 (hereinafter referred to merely as “the game 10”). Those having ordinary skill in the related art should readily appreciate that, although these embodiments of the game 10 are implemented with the structure described in detail below and shown in the drawing, any other suitable card game having rules different than the ones described below can be implemented with such structure.

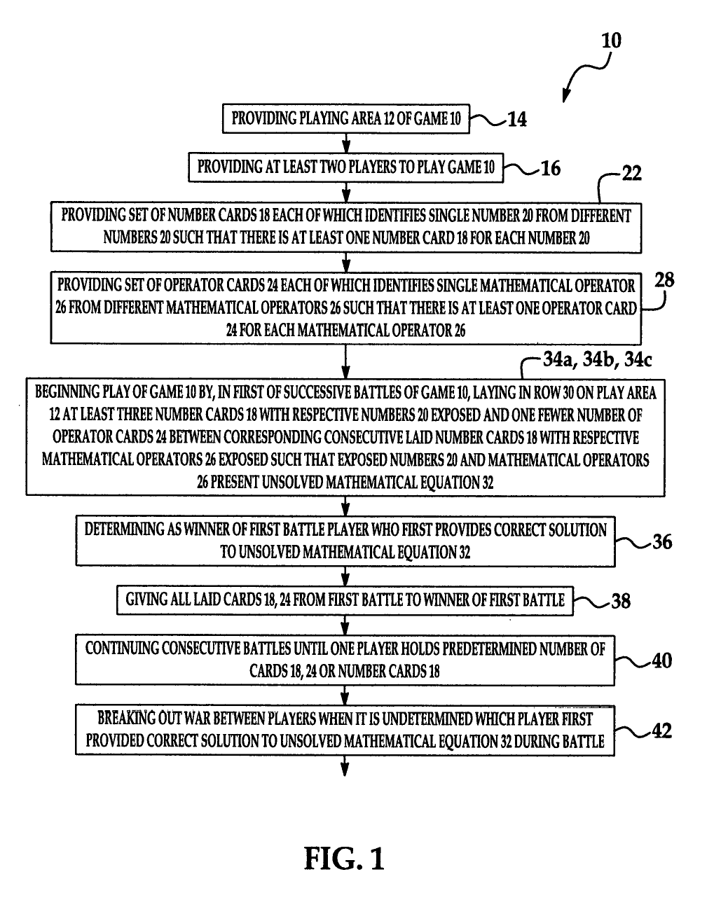

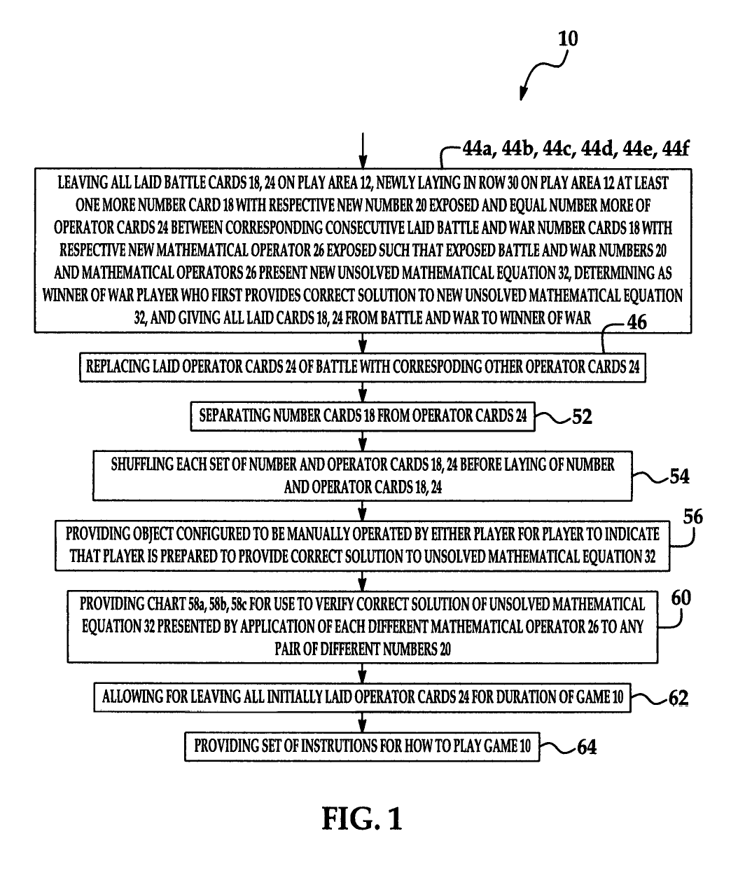

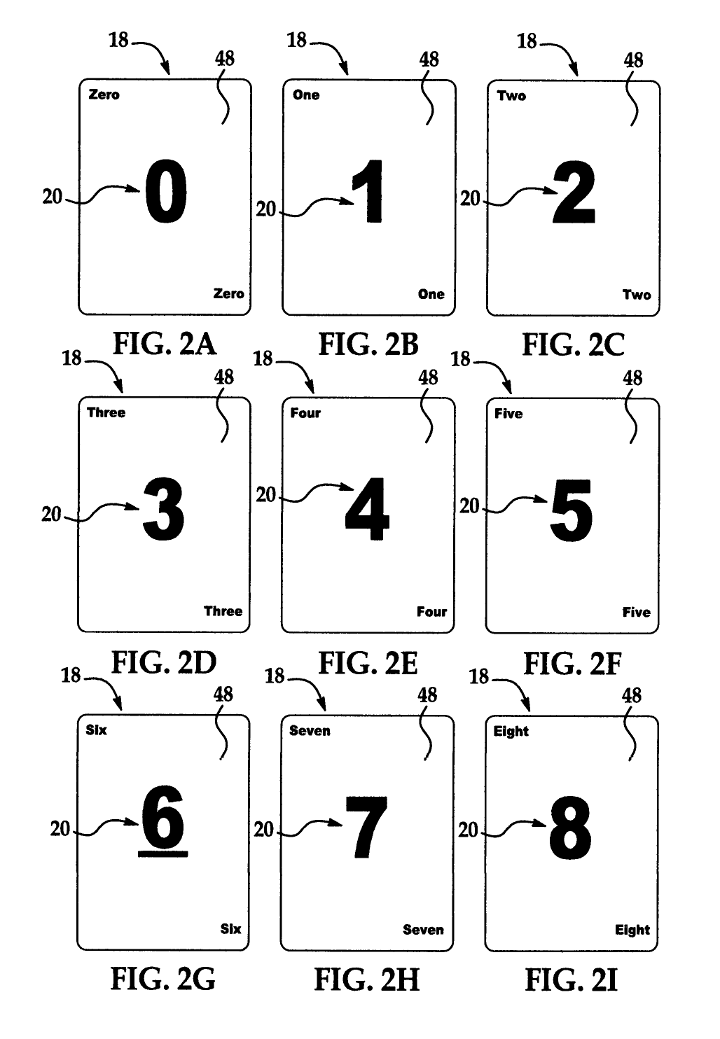

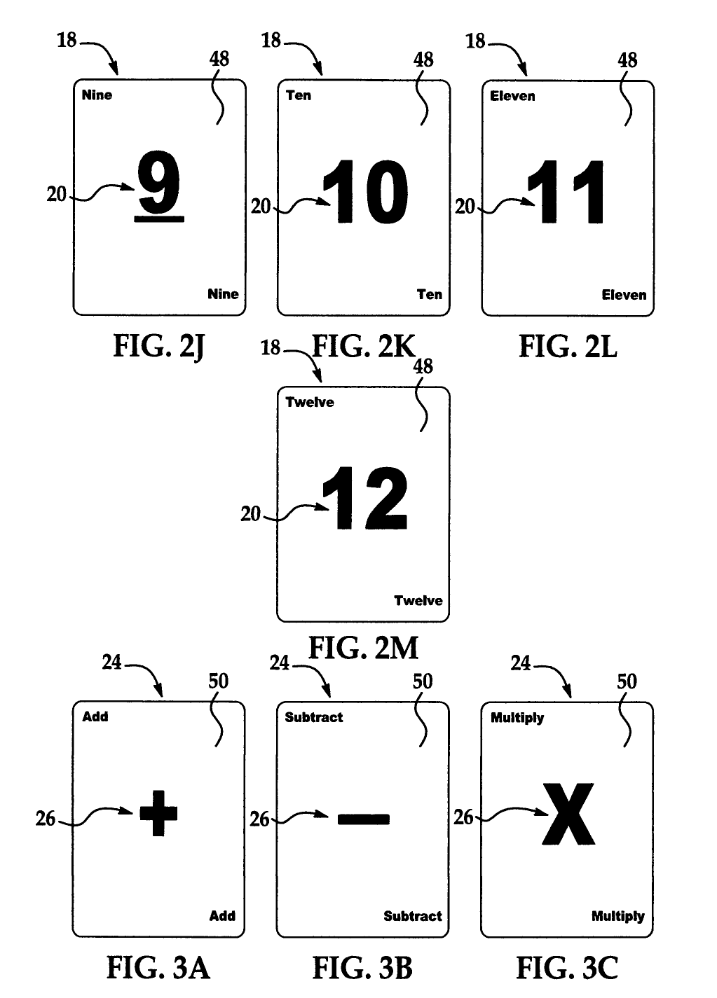

Still referring to the figures (but especially FIG. 1), the method of playing the game 10 includes, in general, at step 14, providing a play area, generally indicated at 12, of the game 10 and, at step 16, providing at least two players (not shown) to play the game 10. At step 22, a set of number cards, generally indicated at 18 in FIGS. 2A-2M, are provided. Each number card 18 identifies a single number, generally indicated at 20, from a plurality of different numbers 20 such that there is at least one number card 18 for each number 20. At step 28, a set of operator cards, generally indicated at 24 in FIGS. 3A-3C, are provided. Each operator card 24 identifies a single mathematical operator, generally indicated at 26, from a plurality of different mathematical operators 26 such that there is at least one operator card 24 for each mathematical operator 26. At step 34a, play of the game 10 begins by, in a first of successive battles of the game 10, at least three number cards 18 being laid in a row, generally indicated at 30 in FIG. 4, on the play area 12 with the respective numbers 20 exposed (i.e., “face up”). At step 34b, one fewer number (i.e., at least two) of operator cards 24 are laid between corresponding consecutive laid number cards 18 with the respective mathematical operators 26 exposed (i.e., “face up”). In this way, at step 34c, the exposed numbers 20 and mathematical operators 26 present an unsolved mathematical equation, generally indicated at 32 in FIG. 4 (consisting of at least a total of five number and operator cards 18, 24). (By the way, the correct solution to the unsolved mathematical equation 32 shown in FIG. 4 is nine.) At step 36, a winner of the first battle is determined as the player who first provides a correct solution (not shown) to the unsolved mathematical equation 32. At step 38, all the laid cards 18, 24 from the first battle are given to the winner of the first battle. At step 40, the consecutive battles are continued until one player holds a predetermined number of the cards 18, 24 or number cards 18.

It should be readily appreciated by those having ordinary skill in the related art that each player can be of any suitable age. Also, as described further below, although a two-player game 10 is described above, three, four, or more players can play the game 10 together as well. It should be so appreciated also that the play area 12 can be any suitable type of play area 12, such as a tabletop 12 or floor 12. It should be so appreciated also that, although a total of seven cards 18, 24 are shown in FIG. 4 laid in the row 30 on the play area 12, any suitable odd number of cards 18, 24 (e.g., five, nine, or eleven) can be laid. It should be so appreciated also that the consecutive battles can be continued (or the game 10 can be played) until one player holds all of the number and operator cards 18, 24 or merely all of the number cards 18. Alternatively, the consecutive battles can be continued until one player holds a majority of the number and operator cards 18, 24 or merely all of the number cards 18 after a certain amount of time has elapsed that is predetermined by the players before the beginning of the game 10. Toward that end, the game 10 can include a timer (not shown) of any suitable kind for tracking the elapsed time.

More specifically and still referring to FIG. 1, in an exemplary embodiment of the method of playing the game 10, at step 42, war is broken out between the players when it is undetermined which player first provided the correct solution to the unsolved mathematical equation 32 during the battle. This situation can arise, for example, when multiple players audibly call out the correct solution at the same time or it is not known which player called out the correct solution first. In this regard, it should be readily appreciated by those having ordinary skill in the related art that the player can provide the correct solution and such player can be determined by any suitable method. For instance, as just mentioned, the player can merely audibly call out the correct solution. Alternatively, at step 56, an object or a device (not shown) can be provided that is configured to be manually operated (e.g., picked up or touched) by either player for the player to indicate that the player is prepared to provide the correct solution. It should be so appreciated also that such device can be any suitable type of device—whether it be electronic, mechanical, or electromechanical—for determining which player first provided the correct solution.

In a version of this embodiment, during the war, at step 44a, all the laid battle cards 18, 24 are left on the play area 12. At step 44b, at least one more number card 18 is newly laid in the row 30 on the play area 12 with the respective new number 20 exposed. At step 44c, an equal number more of operator cards 24 is laid between corresponding consecutive laid battle and war number cards 18 with the respective new mathematical operator 26 exposed. In this way, at step 44d, the exposed battle and war numbers 20 and mathematical operators 26 present a new unsolved mathematical equation 32. By way of illustration using the battle of FIG. 4, two more number cards 18 can be newly laid alternatingly with two more operator cards 24 in the row 30 on the play area 12 with the respective two new numbers 20 and two new mathematical operators 26 exposed (for a total of eleven cards with six numbers 20 and five mathematical operators 26). At step 44e, a winner of the war is determined as the player who first provides a correct solution to the new unsolved mathematical equation 32. At step 44f, all the laid cards 18, 24 from the battle and war are given to the winner of the war. In a form of this version, instead of using the same laid operator cards 24 of the battle during the war, at step 46, the laid operator cards 24 of the battle can be replaced with other corresponding operator cards 24.

Referring now to FIGS. 2A-2M, also in the exemplary embodiment of the method of playing the game 10, the single number 20 is a whole number 20 from zero to twelve such that there is at least one number card 18 for each of the thirteen whole numbers 20. In a version of this embodiment, there are four number cards 18 for each of the thirteen whole numbers 20 such that the game 10 includes fifty-two number cards 18. Also, each number card 18 defines a number face 48 and non-number face (not shown). And, each number face 48, in turn, identifies the single number 20.

More specifically, in a version of this embodiment and as shown, the single number 20 is identified in a substantially central area of the number face 48 of the respective number card 18. But, it should be readily appreciated by those having ordinary skill in the related art that the single number 20 can be identified in any suitable location of the number face 48 and in any suitable manner (i.e., with respect to color, font, size, etc.). Furthermore, the single number 20 is dark and contrasted with a light background. However, it should be so appreciated also that the single number 20 can be light and contrasted with a dark background or any suitable combination between these two extremes. In addition, the single number 20 is written out or printed in letters in each of the upper-left corner and lower-right corner of the number face 48. Yet, it should be so appreciated also that the single number 20 can be written out in any suitable location(s) of the number face 48 in any suitable manner (i.e., with respect to color, font, size, etc.) or not at all. Moreover, the non-number face of the number card 18 may be blank or carry a graphic display, such as a logo. Plus, the number cards 18 are substantially uniform with respect to each other.

It should be readily appreciated by those having ordinary skill in the related art that the single number 20 can be any suitable type of number 20—such as a complex (or an imaginary) number 20, fraction 20, or negative number 20, just to name a few. It should be so appreciated also that the single number 20 can be a number 20 from any suitable range of numbers 20 (e.g., thirteen to twenty-six). It should be so appreciated also that there can be any suitable number of number cards 18 for each of the numbers 20. It should be so appreciated also that the game 10 can include any suitable number of number cards 18. It should be so appreciated also that each number card 18 can have any suitable shape, size, and structure. It should be so appreciated also that each of the number face 48 and non-number face of the number card 18 can have any suitable design.

Referring now to FIGS. 3A-3C, also in the exemplary embodiment of the method of playing the game 10, the different mathematical operators 26 include addition 26, subtraction 26, and multiplication 26. In a version of this embodiment, there are four operator cards 24 for each different mathematical operator 26. Also, each operator card 24 defines an operator face 50 and non-operator face (not shown). And, each operator face 50, in turn, identifies the single mathematical operator 26.

More specifically, in a version of this embodiment and as shown, the operator card 24 substantially mirrors the number card 18. In particular, the mathematical operator 26 is identified in a substantially central area of the operator face 50 of the respective operator card 24. But, it should be readily appreciated by those having ordinary skill in the related art that the mathematical operator 26 can be identified in any suitable location of the operator face 50 and in any suitable manner (i.e., with respect to color, font, size, etc.). Furthermore, the mathematical operator 26 is dark and contrasted with a light background. However, it should be so appreciated also that the mathematical operator 26 can be light and contrasted with a dark background or any suitable combination between these two extremes. In addition, the mathematical operator 26 is written out or printed in letters in each of the upper-left corner and lower-right corner of the operator face 50. Yet, it should be so appreciated also that the mathematical operator 26 can be written out in any suitable location(s) of the operator face 50 in any suitable manner (i.e., with respect to color, font, size, etc.) or not at all. Moreover, the non-operator face of the operator card 24 may be blank or carry a graphic display, such as a logo. Plus, the operator cards 24 are substantially uniform with respect to each other.

It should be readily appreciated by those having ordinary skill in the related art that the mathematical operator 26 can be any suitable type of mathematical operator 26—such as division 26 or factorial 26, just to name a couple. It should be so appreciated also that there can be any suitable number of operator cards 24 for each of the mathematical operators 26. It should be so appreciated also that the game 10 can include any suitable number of operator cards 24. It should be so appreciated also that each operator card 24 can have any suitable shape, size, and structure. It should be so appreciated also that each of the operator face 50 and non-operator face of the operator card 24 can have any suitable design.

Also in the exemplary embodiment of the method of playing the game 10, at step 52, the number cards 18 are separated from the operator cards 24. Then, at step 54, each set of number and operator cards 18, 24 is shuffled before the laying of the number and operator cards 18, 24. In a version of this embodiment, the players lay (or just one of them lays) the number and operator cards 18, 24 in the row 30 on the play area 12. In an alternative version, a non-player (not shown) can lay the number and operator cards 18, 24 in the row 30 on the play area 12 such that the players can fully concentrate on their attempting to solve the unsolved mathematical equation 32.

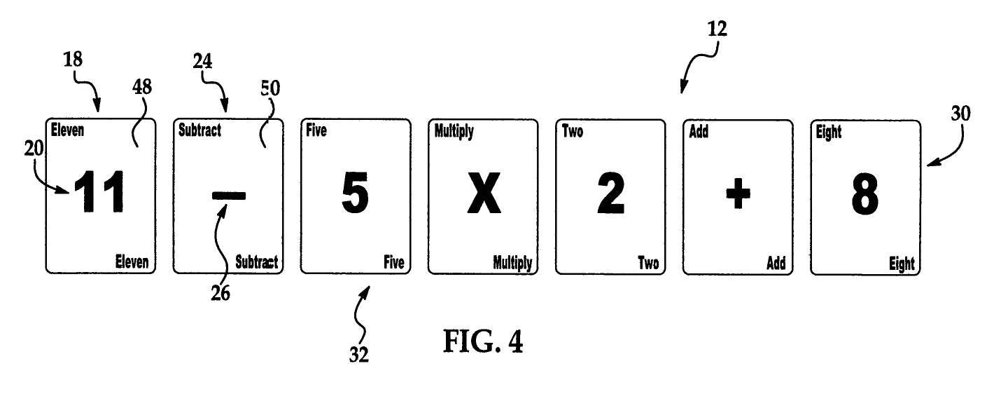

Referring now to FIGS. 5A-5C, also in the exemplary embodiment of the method of playing the game 10, at step 60, a chart or table, generally indicated at 58a, 58b, 58c, is provided for use to verify a correct solution of an unsolved mathematical equation presented by application of each different mathematical operator 26 to any pair of different numbers 20. More specifically, the charts 58a, 58b, 58c respectively provide verification for addition, multiplication, subtraction of whole numbers 20 zero to twelve. Toward that end, each of the charts 58a, 58b, 58c defines a grid, which, in turn, defines a top row of boxes of the grid and a far-left column of boxes of the grid. An upper-left-corner box of the grid is filled with the corresponding mathematical operator 26. Remaining boxes of the top row are respectively filled with the whole numbers 20 zero to twelve consecutively from left to right, and remaining boxes of the far-left column are respectively filled with the whole numbers 20 zero to twelve consecutively from top to bottom. Each of the remaining boxes of the top row begins a corresponding column extending from the top row to the bottom row of the grid, and each of the remaining boxes of the far-left column begins a corresponding row extending from the far-left column to a far-right column of the grid. Every other box of the grid is filled with a number that correlates to the mathematical operator 26, number 20 found in the box located at the top of its column, and number 20 found in the box located at the far left of its row. That is, a correct solution to any mathematical problem presented by any pair of exposed numbers 20 and the mathematical operator 26 disposed between them during play of the game 10 can be found simply by locating the number in the box that is the intersection of the column defined by one exposed number 20 shown at the top row and the row defined by the other exposed number 20 shown at the far-left column.

Also in the exemplary embodiment, at step 64, a set of instructions (not shown) for how to play the game 10 is provided. In this regard, it should be readily appreciated by those having ordinary skill in the related art that the set of instructions can be printed in any suitable manner—such as, but not limited to, on a separate card or separate cards of the game 10 or on a piece of paper.

The game 10 is educational and teaches basic mathematical skills and facts. Also, the game 10 provides for a competitive, entertaining, and fun learning environment and entails competitive play between/among players of the game 10. And, the game 10 interests and excites children about learning mathematics and conveys mathematical concepts to children in a manner to which they can practically relate and by using their interest in games. Furthermore, the game 10 requires fast thinking and can be enjoyed by a wide range of ages, including children and adults. In addition, the game 10 does not require use of any electronic device and integrates use of a broad range of mathematical operations, relationships, and negative numbers 20 into a card game to provide amusement to all players involved the game 10. Moreover, the game 10 does not merely increase memorization or recollection by rote of multiplication tables 58c of integers 20. Plus, the game 10 allows players of the game 10 to understand and practice proper ordering of multiple mathematical operations in an unsolved mathematical equation 32, which further enhance the players' more complex mathematical and strategic-thinking skills of the players, and use their mathematical skills in a fun, unique way. The game 10 is designed to suit any venue in an inexpensive way as well.

The game 10 has been described above in an illustrative manner. Those having ordinary skill in the related art should readily appreciate that the terminology that has been used above is intended to be in the nature of words of description rather than of limitation. Many modifications and variations of the game 10 are possible in light of the above teachings. Therefore, within the scope of the claims appended hereto, the game 10 may be practiced other than as so described.

What is claimed is:

1. A method of playing a math-wars card game comprising steps of:
providing a play area of said game;
providing at least two players to play said game;
providing a set of number cards each of which identifies a single number from a plurality of different numbers such that there is at least one of said number cards for each of said numbers;
providing a set of operator cards each of which identifies a single mathematical operator from a plurality of different mathematical operators such that there is at least one of said operator cards for each of said mathematical operators;
beginning play of said game by, in a first of a plurality of successive battles of said game, laying in a row on said play area at least three of said number cards with said respective numbers exposed and one fewer number of said operator cards between corresponding consecutive ones of said laid number cards with said respective mathematical operators exposed such that said exposed numbers and mathematical operators present an unsolved mathematical equation;
determining as a winner of said first battle said player who first provides a correct solution to said unsolved mathematical equation;
giving all of said laid cards from said first battle to said winner of said first battle; and
continuing said consecutive battles until one of said players holds a predetermined number of either of said number cards and operator cards or number cards.

2. Said method of playing said math-wars card game as set forth in claim 1, wherein said method comprises further a step of breaking out war between said players when it is undetermined which of said players first provided a correct solution to said unsolved mathematical equation during one of said battles.

3. Said method of playing said math-wars card game as set forth in claim 2, wherein said war includes steps of leaving all of said laid battle cards on said play area, newly laying in said row on said play area at least one more of said number cards with said respective new number exposed and an equal number more of said operator cards between corresponding consecutive ones of said laid battle and war number cards with said respective new mathematical operator exposed such that said exposed battle and war numbers and mathematical operators present a new unsolved mathematical equation, determining as a winner of said war said player who first provides a correct solution to said new unsolved mathematical equation, and giving all of said laid cards from said battle and war to said winner of said war.

4. Said method of playing said math-wars card game as set forth in claim 3, wherein said war includes further a step of replacing said at least two laid operator cards of said battle with corresponding other ones of said operator cards.

5. Said method of playing a math-wars card game as set forth in claim 1, wherein said plurality of different mathematical operators include addition, subtraction, multiplication, division, and factorial.

6. Said method of playing said math-wars card game as set forth in claim 1, wherein said single number is a whole number from zero to twelve such that there is at least one of said number cards for each of said thirteen whole numbers.

7. Said method of playing said math-wars card game as set forth in claim 6, wherein there are four of said number cards for each of said thirteen whole numbers such that said set of number cards includes fifty-two number cards.

8. Said method of playing said math-wars card game as set forth in claim 1, wherein each of said number cards defines a number face and non-number face, each of said number faces identifying said single number.

9. Said method of playing said math-wars card game as set forth in claim 1, wherein there are four of said operator cards for each of said plurality of different mathematical operators.

10. Said method of playing said math-wars card game as set forth in claim 1, wherein each of said operator cards defines an operator face and non-operator face, each of said operator faces identifying said single mathematical operator.

11. Said method of playing said math-wars card game as set forth in claim 1, wherein said method comprises further a step of separating said number cards from said operator cards.

12. Said method of playing said math-wars card game as set forth in claim 1, wherein said method comprises further a step of shuffling each of said sets of number and operator cards before said laying of said number and operator cards.

13. Said method of playing said math-wars card game as set forth in claim 1, wherein said method comprises further a step of allowing for leaving all of said initially laid operator cards for a duration of said game.

14. Said method of playing said math-wars card game as set forth in claim 1, wherein said players lay said number and operator cards in said row on said play area.

15. Said method of playing said math-wars card game as set forth in claim 1, wherein a non-player lays said number and operator cards in said row on said play area.

16. Said method of playing said math-wars card game as set forth in claim 1, wherein said method comprises further a step of providing an object configured to be manually operated by either of said players for said player to indicate that said player is prepared to provide said correct solution to said unsolved mathematical equation.

17. Said method of playing said math-wars card game as set forth in claim 1, wherein said method comprises further a step of providing a chart for use to verify a correct solution of an unsolved mathematical equation presented by application of each of said plurality of different mathematical operators to any pair of said plurality of different numbers.

18. Said method of playing said math-wars card game as set forth in claim 17, wherein said charts respectively provide said verification for addition, multiplication, subtraction of whole numbers zero to twelve.

19. Said method of playing said math-wars card game as set forth in claim 1, wherein said method comprises further a step of providing a set of instructions for how to play said game.

20. Said method of playing said math-wars card game as set forth in claim 1, wherein said play area includes a table.
